(19) United States
(12) Patent Application Publication
(10) Pub. No.: US 2007/0269245 A1
(43) Pub. Date: Nov. 22, 2007

(54) Fixing device, fixing member used therefor, and image forming apparatus

(75) Inventors: Tohru Inoue, Ebina-shi (JP); Aya Kakishima, Ashigarakami (JP); Atsumi Kurita, Ashigarakami-gun (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/639,219

(22) Filed: Dec. 15, 2006

(30) Foreign Application Priority Data
May 19, 2006 (JP) 2006-140716

(51) Int. Cl. G03G 15/20

(52) U.S. Cl. 399/333

(57) ABSTRACT

A fixing member includes: a core material; and a coating layer that coats the core material, in which a wear-resistance imparting additive with an average particle diameter of up to approximately 1 μm is dispersed.

### BACKGROUND

1. Technical Field

The present invention relates to a fixing device, a fixing member used for the fixing device, and an image forming apparatus.

2. Related Art

In an electrophotographic method, electrostatic recording method, electrostatic printing method or the like, a latent image formed on a latent image carrier configured with a photoconductive photoreceptor or dielectric material or the like is developed using toner. A toner image is transferred to the paper, and fixed to the paper by the fixing device. A hot roller fixing method is widely adopted as the toner fixing method, because such a method provides high heat efficiency and enables high speed fixing. With a hot roller fixing method, paper carrying an unfixed toner image is sandwiched at a contact region formed by a fixing roller (fixing member) provided with a heat source and a pressure roller (pressure member) pressed against the fixing roller, and the toner image is fixed to the paper by melting with heat and application of pressure.

Efficiency of fixing depends on how quickly the temperature of toner particles increases to the resin softening point of the toner particles. Thus, in order to increase fixing efficiency, low-softening resin with a low softening point is included in the toner bonding resin. In this case however, part of the toner image is affixed to the surface of the fixing roller when fixing, and thus phenomena are likely to occur such as a hot offset phenomenon in which the affixed toner is transferred to the paper, thus staining the paper, or a rolling phenomenon in which the paper sticks to the surface of the fixing roller and is rolled around that roller. Also, a blocking phenomenon may be caused in which, when the paper is stacked and stored after the toner image has been fixed, sheets of paper are stuck to each other by the toner.

On the other hand, the fixing roller is required to transport the paper along a predetermined path while preventing offset of melted toner. That is, the fixing roller is required to possess excellent separability. Also, it is required to have an ability to maintain this separability over a long period of time. Also, the fixing roller is required to be excellent in terms of wear resistance and thermoconductivity.

### SUMMARY

An aspect of the present invention provides a fixing member having a core material and a coating layer that coats the core material, a wear-resistance imparting additive with an average particle diameter of up to approximately 1 μm being dispersed in the coating layer.

### BRIEF DESCRIPTION OF THE DRAWINGS

Exemplary embodiments of the present invention will be described in detail based on the following figures, wherein:

FIG. 1 shows the configuration of a fixing device 11 according to an exemplary embodiment of the invention;

FIG. 2 shows an image used for testing; and

FIG. 3 shows an image forming apparatus 1 provided with the fixing device 11.

### DETAILED DESCRIPTION

An exemplary embodiment of the present invention will be described with reference to the drawings.

### <Configuration>

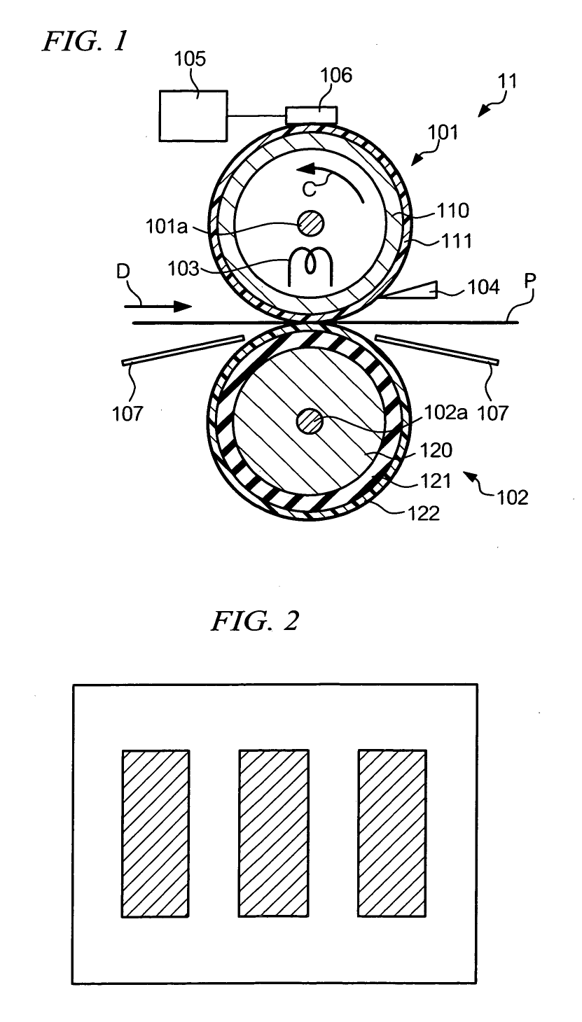

FIG. 1 shows the configuration of a fixing device 11 according to an exemplary embodiment of the invention.

The fixing device 11 includes a fixing roller (fixing member) 101 equipped with a heater 103 as a heat source, and a pressure roller (pressure member) 102 pressed against the fixing roller 101. Shafts 101a and 102a are supported by a bearing (not shown), and the fixing roller 101 and the pressure roller 102 are rotatable using the shafts 101a and 102a respectively as rotating shafts. Motive power generated by a motor (not shown) is transmitted to the fixing roller 101 by a gear or the like (not shown), and thus the fixing roller 101 is rotatably driven in the direction of arrow C. Paper P (recording medium), onto which an unfixed toner image has been transferred, is caused by a transport mechanism (not shown) to enter into a contact region formed by the fixing roller 101 and the pressure roller 102 in a state with a toner image facing the fixing roller 101, transporting the paper P in the direction of arrow D with frictional force produced between the paper P and the surface of the fixing roller 101.

A separation catch 104 that prevents the paper P from wrapping around the fixing roller 101 is provided downstream of the contact region. The separation catch 104 has a spring (not shown), and the end portion of the separation catch 104 is pressed against the surface of the fixing roller 101 by the elastic force of the spring. A thermistor 106 is provided above the fixing roller 101, and measures the surface temperature of the fixing roller 101. A temperature adjustment apparatus 105 controls the heater 103 based on the temperature measured by the thermistor 106, and thus the surface temperature of the fixing roller 101 is maintained at about 180° C. Guides 107 for guiding the paper P along a transport path are provided on the upstream and downstream sides of the contact region.

The fixing roller 101 is configured from, for example, an aluminum pipe (core material) 110 with a thickness of 5 mm, a length in the axial direction of 350 mm, and a diameter of 65 mm, and a resin layer (coating layer) 111 with a thickness of 30 μm, made of fluorocarbon resin, that coats the outer circumference of the pipe 110. The fluorocarbon resin is, for example, PFA. The resin layer 111 is formed by wet coating, and is used as a releasing layer for facilitating the removal of paper P on which a toner image has been fixed from the fixing roller 101. Moreover, a content of 3 to 20 wt % of a wear-resistance imparting additive with an average particle diameter of not more than 1 μm is dispersed in the resin layer 111. The wear-resistance imparting additive is, for example, a silicon carbide and acts to improve the wear-resistance of the resin layer 111.

In the configuration of the pressure roller 102, for example, a porous silicon rubber layer 121 with a thickness of 12 mm and rubber hardness 60 (JIS-A) is wrapped around the surface of a cored round steel bar 120, wherein plating is executed on the surface of the bar, the bar having a length in the axial direction of 350 mm and a diameter of 41 mm, and moreover that surface is coated with a resin layer 122 made from a PFA tube with a thickness of 100 μm. Carbon particles are dispersed in the silicon rubber layer 121 as an electrically conductive additive, the resistance value in the thickness direction thereof is adjusted to 10⁶ Ω, and the silicon rubber layer 121 is electrically grounded. Also, carbon particles are dispersed in the resin layer 122 as an electrically conductive additive, and the resistance value in the thickness direction thereof is adjusted to 10⁵ Ω.

The fixing roller 101 and the pressure roller 102 are pressed against each other with a load of 240 kgf, forming a contact region of approximately 9 mm in the paper transport direction. The fixing roller 101 is rotatably driven with a velocity of 460 mm/sec by a motor.

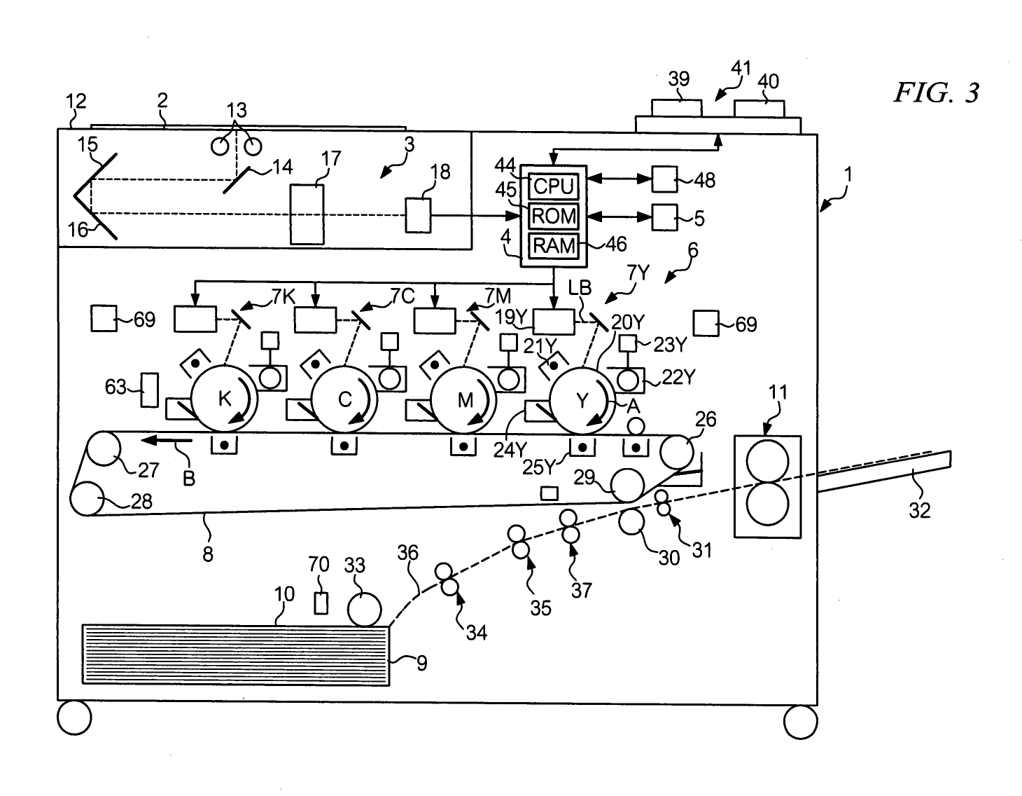

FIG. 3 shows an image forming apparatus 1 provided with the fixing device 11 according to an exemplary embodiment of the invention. The image forming apparatus 1 is, for example, a copy machine.

Operation of each portion of the image forming apparatus 1 is controlled by a control portion 4 executing a program stored in a storage portion 5. An image input portion 12 is a scanner apparatus that optically captures data of an original image and outputs an electrical signal. The control portion 4 produces raster image data that expresses an image of each color yellow, magenta, cyan, and black based on the electrical signal.

An image output portion 6 is configured from, for example, image forming engines 7Y, 7M, 7C, and 7K, and a transfer belt 8. The image forming engines 7Y, 7M, 7C, and 7K respectively form toner images of each color yellow (color Y), magenta (color M), cyan (color C), and black (color K). The configuration of each image-forming engine is the same, so here only the image-forming engine 7Y is described.

A photosensitive drum 20Y is a cylindrically formed photosensitive body, whose circumferential surface has photoconductivity. A charging apparatus 21Y charges the surface of the photosensitive drum 20Y, which is rotatably driven in the direction of arrow A, to a predetermined potential. An exposing apparatus 19Y is a scanning optical system that irradiates an exposing beam LB to the photosensitive drum 20Y, and forms an electrostatic latent image on the surface of the photosensitive drum 20Y based on the raster image data.

A development apparatus 22Y forms a toner image by causing toner to affix to the electrostatic latent image formed on the surface of the photosensitive drum 20Y. The toner image formed on the surface of the photosensitive drum 20Y is transferred to the surface of the transfer belt 8 (primary transfer) by the operation of an electric field produced by voltage applied to a transfer apparatus 25Y.

In the image forming engines 7M, 7C, and 7K also, toner images corresponding to each color are formed and transferred stacked onto the transfer belt 8.

When a full-color toner image is formed on the surface of the transfer belt 8, a paper supply roller 33 is rotatably driven, feeding recording sheets 10 page by page. The toner image on the transfer belt 8 is transferred to the surface of the recording sheet 10 by the operation of an electrical field produced by the voltage applied to a transfer roller 30, and the load pressing the transfer roller 30 against the transfer belt 8 (secondary transfer).

The recording sheet 10 on which a toner image has been transferred is guided to the fixing device 11. With the fixing device 11, heat and pressure are applied to the recording sheet 10, fixing the toner image on the surface of the recording sheet 10. The recording sheet 10 on which the toner image has been fixed is then discharged to a discharge tray 32.

The image-forming apparatus 1 described above is only one example; the present invention is suitable for an apparatus having any configuration, as long as it is an image forming apparatus in which a toner image is formed on a recording medium, and this toner image is fixed on the recording medium by application of heat and pressure to the toner image.

Table 1 shows the results of a test performed to investigate the hot offset generated, with the content of silicon carbide in the resin layer 111 of the fixing roller 101 used as a parameter. In this test, using silicon carbide with an average particle diameter of 0.5 μm, resin layers 111 are formed with wet coating, modifying the content of silicon carbide in five levels. For the sake of comparison, resin layers 111 including 12 wt % of silicon carbide with average particle diameters of 1.5 μm and 3.5 μm are formed with powder coating (dry coating). In these seven cases, after consecutively duplicating the image shown in FIG. 2 on both sides of 100,000 sheets of A4-size plain paper, a whole-sheet halftone image with an image density of 50% is consecutively duplicated on 10 sheets of A3-size plain paper, and the hot offset occurring at this time is investigated. The average particle diameter of the silicon carbide used is obtained by calculating the volume average particle diameter using a particle size distribution measuring apparatus (product name: Microtrac MT3300, Nikkiso Co., Ltd.) employing a laser diffraction-scattering method.

As a result, as shown in Table 1, it is found that the least amount of hot offset occurred in the case of average particle diameter 0.5 μm, content 8 to 13 wt %, and wet coating. That is, this case resulted in the best separability and ability to maintain that separability. Also, the amount of wear of the resin layer 111 after testing is not more than 10 μm, so there is no problem relating to wearability.

TABLE 1

| Silicon | | | |
|---|---|---|---|
| Carbide | | | |
| Average | | | |
| Particle | Content of Silicon | | Occurrence of |
| Diameter | Carbide (wt %) | Coating Method | Offset |
| 0.5 μm | less than 3 | wet coating | much |
| | 3 to less than 8 | | little |
| | 8 to less than 13 | | very little |
| | 13 to less than 20 | | little |
| | 20 or more | | much |
| 1.5 μm | 12 | powder coating | much |
| 3.5 μm | 12 | | very little |

Next, a description is given of the function and effect of the fixing roller 101 according to an exemplary embodiment of the invention compared with a fixing device according to the conventional technology.

First, in a conventional fixing device, in order to prevent electrostatic toner offset to the fixing roller, a measure is adopted of reducing the surface potential of the pressure roller by grounding the fixing roller to lower its surface resistance. In this configuration, a case is considered in which acid-free paper is used, and in the copied image there is a portion in the axial direction of the fixing roller where there is no image at all. In this case, the back of the paper is positively charged by application of a transfer voltage with a polarity opposite to that of the toner charge polarity in the secondary transfer, which is a prior process. Because the content of calcium carbonate in acid-free paper is large, this calcium carbonate is also positively charged. Thus, calcium carbonate in the back of the paper causes electrostatic induction with the surface of the grounded pressure roller, so that an attraction force is produced between the calcium carbonate and the pressure roller. A portion of the calcium carbonate in the back of the paper is affixed to the surface of the pressure roller by this attraction force. The fixing roller and the pressure roller are in direct contact from the time that the paper is discharged from the contact region until the next sheet of paper enters into the contact region, and during this time the calcium carbonate affixed to the surface of the pressure roller moves to the surface of the fixing roller. When the next sheet of paper enters into the contact region, the calcium carbonate on the fixing roller moves to the melted toner in the portion where a toner image is present on the paper. In the portion where a toner image is not present on the paper, the calcium carbonate remains affixed to the fixing roller.

Also, conventionally silicon carbide is dispersed in the surface of the fixing roller in order to improve wear resistance and separability. However, an improvement in wear resistance has a secondary effect of making it difficult to perform abrasive cleaning with paper of calcium carbonate affixed to the surface of the fixing roller. Thus, calcium carbonate accumulates on the fixing roller as time passes, and ultimately the surface of the fixing roller is positively charged. When the surface of the fixing roller is coarse, the calcium carbonate enters into its uneven surface, and abrasive cleaning becomes still more difficult.

Increasing the amount of positive charge of the fixing roller in this manner causes negatively charged toner to be attracted to the fixing roller, and as a result, toner offset increases as time passes.

On the other hand, in the exemplary embodiment of the invention, silicon carbide with an average particle diameter of not more than 1 μm is dispersed in the PFA resin layer 111. Thus, because the surface of the resin layer 111 remains smooth even after wear, abrasive cleaning is easily performed by paper or the like even when calcium carbonate is affixed. Also, separability and the ability to maintain that separability are preserved.

Also, in the exemplary embodiment of the invention, the content of silicon carbide is not less than 3 wt %. The reason for this is as follows. When the particle diameter of the silicon carbide is reduced, when the resin layer is worn, isolated silicon carbide particles are easily peeled away from the base material PFA, and as result, there is a decrease in wear resistance. In the exemplary embodiment of the invention, the content of silicon carbide is increased, so even if silicon carbide is peeled away due to wear, a sufficient amount of silicon carbide remains in the resin layer. Thus, it is possible to suppress the decrease in wear resistance. Also, a decrease in thermoconductivity can be suppressed. However, when the content of silicon carbide is too great, the proportion of silicon carbide deposited on the surface of the fixing roller increases, and the initial separability decreases, so it is desirable that the content of silicon carbide is not more than 20 wt %.

Also, in the exemplary embodiment of the invention, the PFA resin layer 111 is formed by wet coating (also referred to as flow coating). Conventionally, powder coating (dry coating) is mainly used, but because with this method it is difficult to uniformly disperse the silicon carbide in the PFA resin, when the fixing roller is worn the surface of the fixing roller easily becomes rough, so calcium carbonate is easily deposited. With wet coating, because it is easy to uniformly disperse the silicon carbide in the PFA resin, even when the fixing roller is worn, the surface of the fixing roller does not easily become rough, so calcium carbonate is not easily deposited.

As described above, according to an exemplary embodiment of the invention, it is possible to improve separability and the ability to maintain of that separability, resistance to wear, and thermoconductivity of the fixing roller.

### MODIFIED EXAMPLE

The present invention can be embodied in various forms, and is not limited to the exemplary embodiment described above. For example, the above exemplary embodiment can be modified as described below.

In the above exemplary embodiment, an example is given in which the present invention is applied to a hot roller fixing-type fixing device, but the present invention is not limited to such an application. For example, the present invention is also suitable for a hot belt fixing-type fixing device or the like in which toner is fixed on a recording medium by application of heat to a toner image via a thin heat-resistant belt. In this case, the fixing member is formed by covering the surface of an endless belt constituted from a polyimide or the like with PFA resin in which silicon carbide has been dispersed. This belt is stretched with tension by multiple rollers, and a pressure roller (pressure member) is pressed against one of the multiple rollers via the belt, forming a contact region. Along with heating of the belt by a heat source, the belt is circularly driven, so that paper supporting an unfixed toner image is caused to enter into the contact region. The toner that has entered into the contact region is melted, and pressure is applied to that toner, fixing the toner on the paper. With this configuration as well, the same effects as in the exemplary embodiment above are obtained.

In the above exemplary embodiment, an example is given in which the present invention is applied to an electrophotographic image forming apparatus, but the present invention is applicable to any apparatus, as long as it is an image forming apparatus employing an electrostatic recording method or electrostatic printing method or the like, in which a toner image formed on a recording medium is melted with heat, and this toner image is fixed on the recording medium by application of pressure to the toner image.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The exemplary embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing member, comprising:
a core material; and
a coating layer that coats the core material, in which a wear-resistance imparting additive with an average particle diameter of up to approximately 1 μm is dispersed.

2. The fixing member according to claim 1, wherein the wear-resistance imparting additive is dispersed in the coating layer with a content of from approximately 3 wt % to approximately 20 wt %.

3. The fixing member according to claim 1, wherein the wear-resistance imparting additive is silicon carbide.

4. The fixing member according to claim 1, wherein the coating layer is formed on the surface of the core material by performing wet coating.

5. A fixing device, comprising:
a fixing member having a core material and a coating layer that coats the core material, a wear-resistance imparting additive with an average particle diameter of up to approximately 1 μm being dispersed in the coating layer;
a heat source that heats the fixing member; and
a pressure member pressed against the fixing member via the coating layer.

6. An image forming apparatus, comprising:
an image output unit that forms a toner image on a recording medium;
a transport unit that transports the recording medium on which the toner image is formed by the image output unit; and
a fixing device that fixes the toner image on the recording medium transported by the transport unit, the fixing device comprising:
a fixing member having a core material and a coating layer that coats the core material, a wear-resistance imparting additive with an average particle diameter of up to approximately 1 μm being dispersed in the coating layer;
a heat source that heats the fixing member; and
a pressure member pressed against the fixing member via the coating layer.
